(19) United States
(12) Patent Application Publication
(10) Pub. No.: US 2016/0023702 A1
(43) Pub. Date: Jan. 28, 2016

(54) ADJUSTING DEVICE FOR A BICYCLE SADDLE

(71) Applicant: Chien-Yi Lin, Taichung City (TW)

(72) Inventor: Chien-Yi Lin, Taichung City (TW)

(21) Appl. No.: 14/340,581

(22) Filed: Jul. 25, 2014

(51) Int. Cl. B62J 1/08

(52) U.S. Cl. CPC B62J 1/08

(57) ABSTRACT

An adjusting device for a saddle, which is adapted to be mounted between two saddle rails and a seat post, includes a bracket having a barrel portion and an extending portion. The barrel portion has an axial hole and the extending portion has a cavity communicating with the axial hole. An inner tube is received in the barrel portion and cooperates with two caps to clamp the two saddle rails. An engaging block is received in the cavity of the extending portion and a controlling member for securing the engaging block, wherein the engaging block is configured to engage with the inner tube. The controlling member is rotated in a tight state where the engaging block is engaged with the inner tube, and in a loose state where the engaging block is disengaged from the inner tube so that an inclined angle of the saddle is allowed to be adjusted.

### BACKGROUND OF THE INVENTION

1. Field of the Invention

The present invention relates to a bicycle saddle, and more particularly to an adjusting device for a bicycle saddle.

2. Description of Related Art

Bicycle activity is more and more popular in these days because it is eco-friendly, convenient and entertaining. Most modern bicycles have a seat adjusting device in order to secure a saddle to a seat post.

A conventional seat adjusting device for a bicycle as illustrated in U.S. Pat. No. 8,083,289, comprises a seat post, two engaging blocks, two covers and a fixing bolt. The seat post has a retaining portion defined at a top end thereof. The two engaging blocks are engaged with two sides of the retaining portion of the seat post respectively. The two covers are disposed at two outer sides of the two engaging blocks respectively. Each cover is coupled with the respective engaging block. The fixing bolt passes through the two covers, the two blocks and the retaining portion of the seat post and tightened. The rails of a saddle are positioned and secured by the two covers respectively coupled with the corresponding engaging blocks so that the saddle is secured on the seat post.

Although the conventional seat adjusting device could adjust the position of the saddle, the conventional seat adjusting device needs another tool to loosen the fixing bolt so as to adjust the position of the saddle. It is inconvenient for a user to operate.

The present invention has arisen to mitigate and/or obviate the disadvantages of the conventional seat adjusting device.

### SUMMARY OF THE INVENTION

The main objective of the present invention is to provide an improved adjusting device for a bicycle saddle.

To achieve the objective, an adjusting device for a saddle, which is adapted to be mounted between two saddle rails and a seat post, comprises a bracket, a supporting assembly and an adjusting assembly. The bracket is mounted on a top of the seat post, and has a barrel portion and an extending portion defined at an outer periphery of the barrel portion. The barrel portion has an axial hole and an opening defined in an inner wall of the barrel portion. The extending portion has a cavity communicating with the axial hole of the barrel portion via the opening. The supporting assembly for clamping the two saddle rails has an inner tube rotatably disposed in the barrel portion of the bracket and two caps fixed on two opposite ends of the inner tube. The inner tube has a first toothed face corresponding to the opening of the barrel portion. The adjusting assembly is disposed in the cavity of the extending portion, and has an engaging block and a controlling member. The engaging block has a second toothed face for engagement with the first toothed face of the inner tube to retain the inner tube. The controlling member passes through the engaging block and is locked in a wall of the cavity for securing the engaging block.

Under this arrangement, the controlling member is rotated in a tight state where the engaging block is engaged with the inner tube, and in a loose state where the engaging block is disengaged from the inner tube so that an inclined angle of the saddle is allowed to be adjusted.

Preferably, the engaging block is substantially L-shaped which defines a concave corresponding to the opening of the barrel portion, and the first toothed face is disposed on a wall of the concave.

Preferably, the adjusting assembly further comprises an elastic member interposed between the wall of the cavity and the engaging block. The engaging block has a recess for accommodating the elastic member.

Preferably, the controlling member has a bolt portion and an operating head. The bolt portion has a thread section at one end thereof for being screwed in the wall of the cavity. Specifically, the operating head is arranged outside the extending portion for controlling movement of the engaging block. In addition, a lighting device could be mounted on the operating head of the controlling member opposite to the bolt portion.

Preferably, the inner tube has two notches corresponding to the two saddle rails and each of the two caps has a clamping groove cooperating with the respective notch of the inner tube to clamp the associated saddle rail. A fastener laterally passes through the two caps for securing the two caps with each other.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of an adjusting device for a saddle in accordance with a preferred embodiment of the present invention, wherein the adjusting device is adapted to be mounted between two saddle rails and a seat post;

FIG. 2 is an exploded perspective view of the adjusting device for the saddle shown in FIG. 1;

FIG. 3 is a cross-sectional view of the adjusting device for the saddle along line III-III of FIG. 1;

FIG. 4 is a partial enlarged view of FIG. 3;

FIG. 5 illustrates that the engaging block is disengaged from the inner tube by rotation of the controlling member;

FIG. 6 illustrates that the inclined angle of the saddle is adjusted; and

FIG. 7 illustrates that the engaging block is disengaged with the inner tube by rotation of the controlling member.

### DETAILED DESCRIPTION OF THE INVENTION

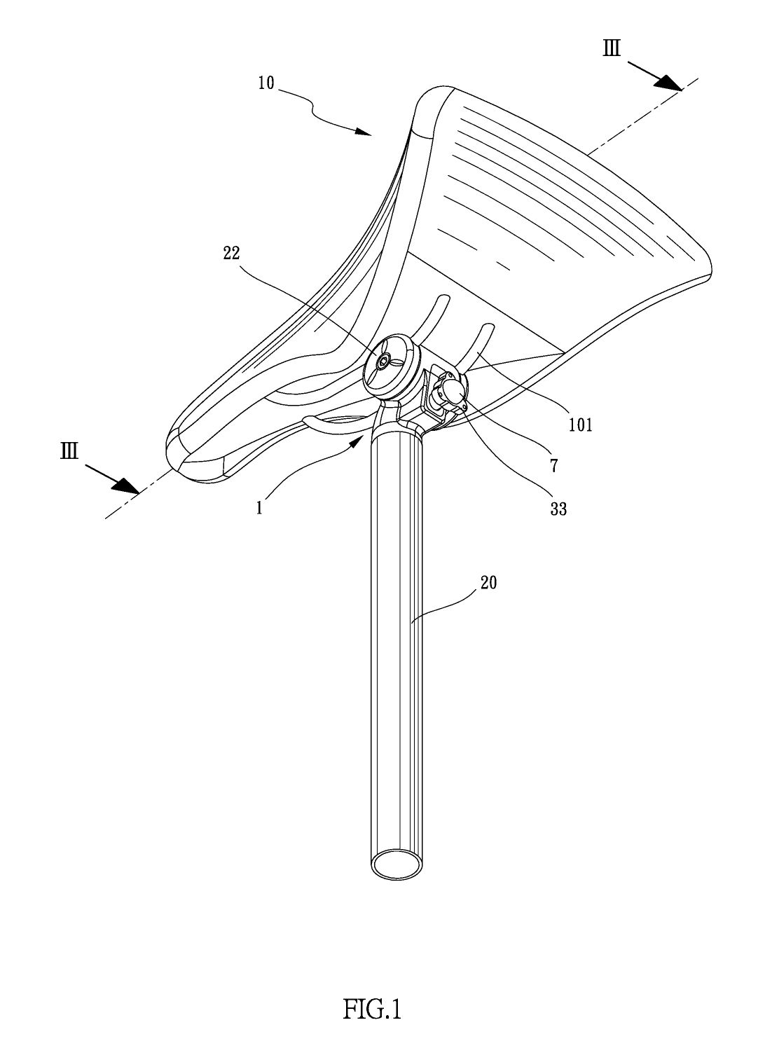

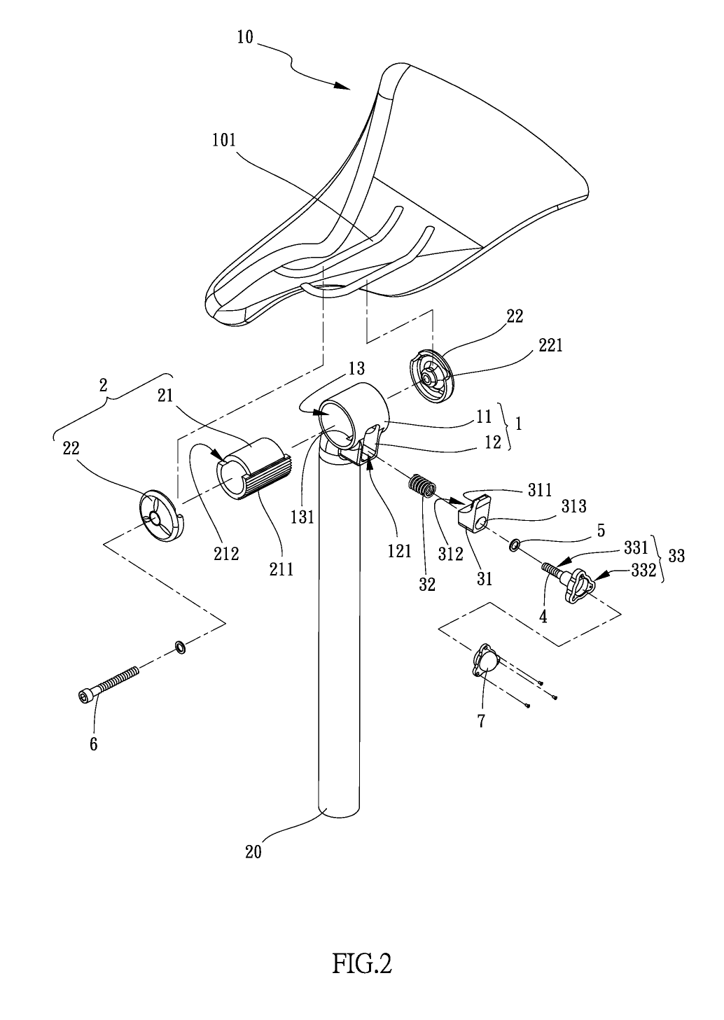

Referring to FIGS. 1-4, an adjusting device for a saddle 10 in accordance with a preferred embodiment of the present invention which is adapted to be mounted between two saddle rails 101 and a seat post 20, comprises a bracket 1 mounted on a top of the seat post 20, a supporting assembly 2 for clamping the two saddle rails 101, and an adjusting assembly 3. The bracket 1 has a barrel portion 11 and an extending portion 12 defined at an outer periphery of the barrel portion 11, wherein the extending portion 12 is disposed at a rear side of the bracket, as shown in FIG. 2. The barrel portion 11 has an axial hole 13 therethrough and an opening 131 defined in an inner wall of the barrel portion 11 and corresponding to the extending portion 12. The extending portion 12 has a cavity 121 communicating with the axial hole 13 of the barrel portion 11 via the opening 131.

The supporting assembly 2 has an inner tube 21 rotatably disposed in the barrel portion 11 of the bracket 1 and two caps 22 fixed on two opposite ends of the inner tube 21 to retain the inner tube 21 in the barrel portion 11 of the bracket 1. The inner tube 21 has a first toothed face 211 corresponding to the opening 131 of the barrel portion 11. The adjusting assembly 3 is disposed in the cavity 121 of the extending portion 12, and has an engaging block 31, an elastic member 32 and a controlling member 33. The engaging block 31 has a second toothed face 311 for engagement with the first toothed face 211 of the inner tube 21 to retain the inner tube 21. The elastic member 32 is interposed between a wall of the cavity 121 and the engaging block 31. The controlling member 33 passes through the engaging block 31 and is locked in the wall of the cavity 121 for securing the engaging block 31.

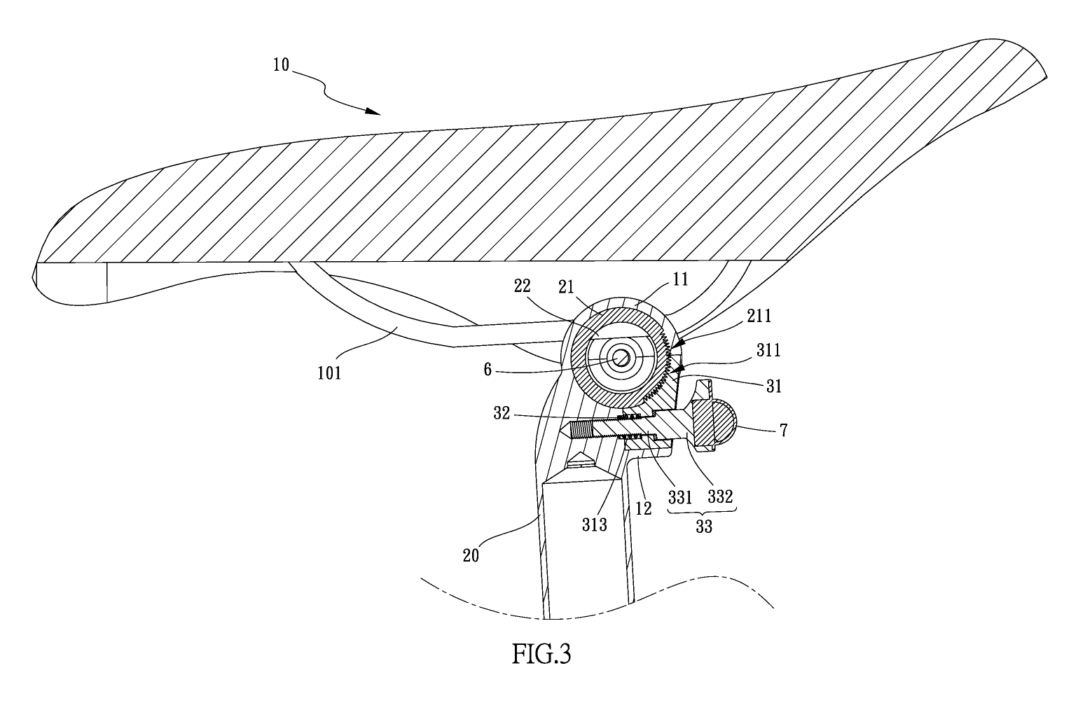

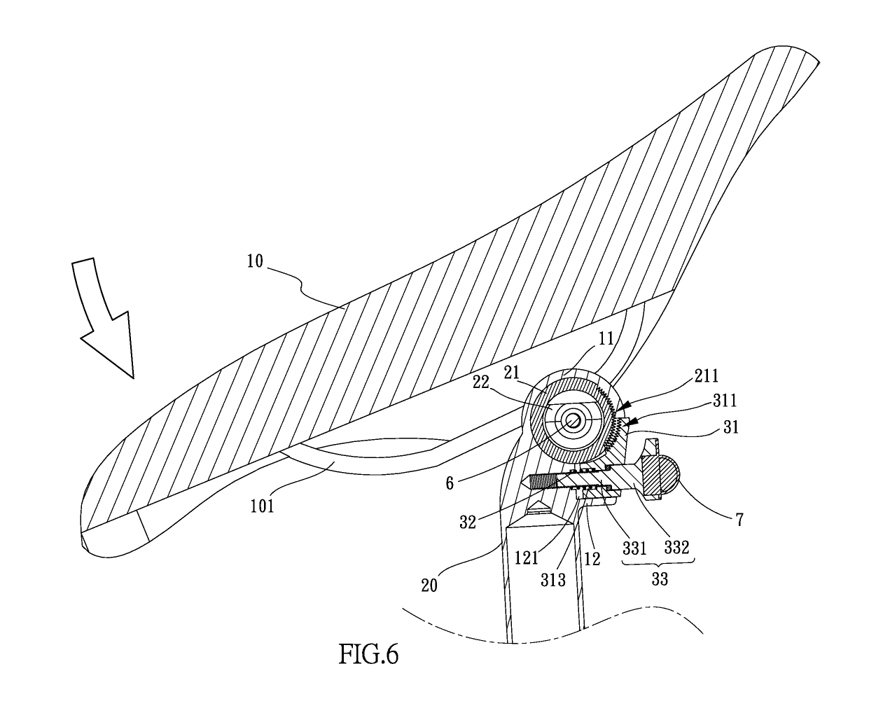

Under this arrangement, the controlling member 33 could be rotated in a tight state where the engaging block 31 is engaged with the inner tube 21 as shown in FIG. 3, and rotated in a loose state where the engaging block 31 is disengaged from the inner tube 21 so that an inclined angle of the saddle 10 is allowed to be adjusted, as shown in FIG. 6.

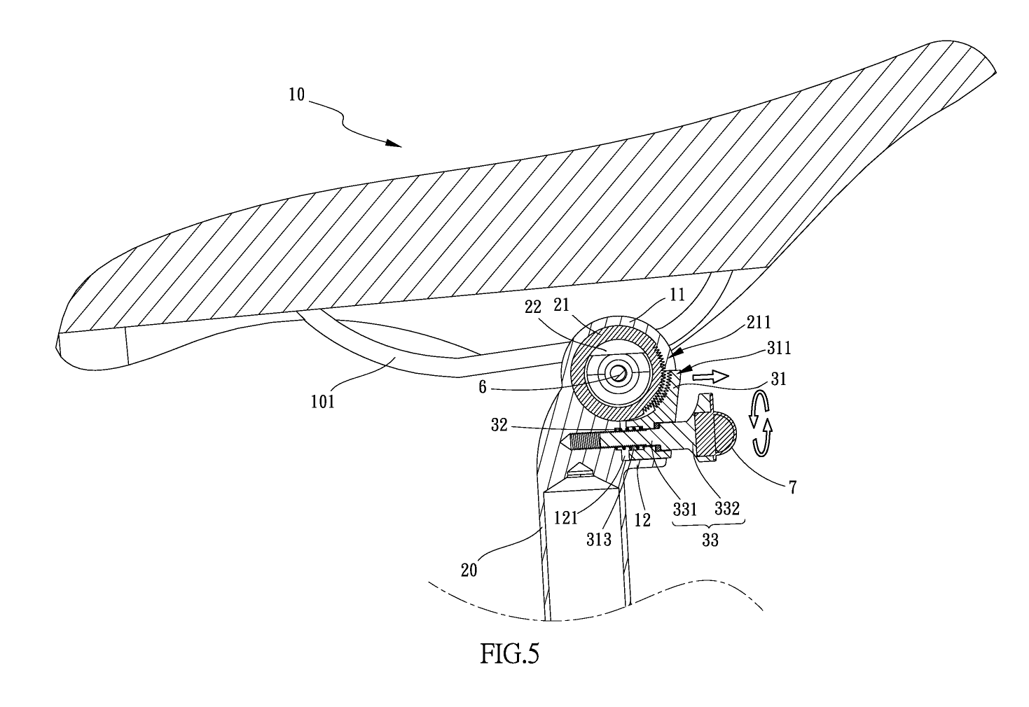

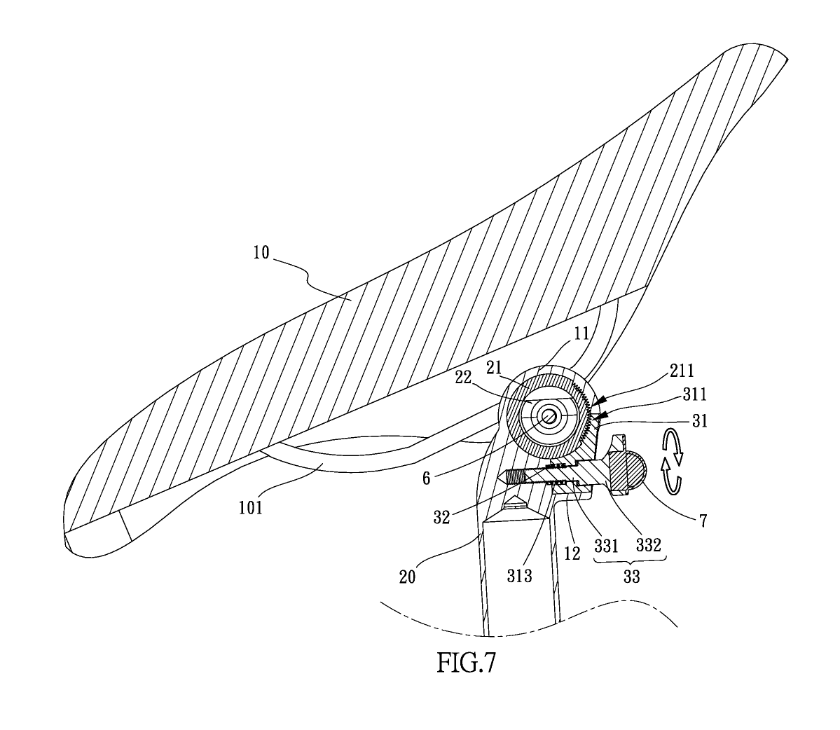

Referring to FIGS. 5-7, as the controlling member 33 is operated to be loosed by means of screw, the elastic member 32 would abut against the engaging block 31 to move outward such that the second toothed face 311 of the engaging block 31 is disengaged from the first toothed face 211 of the inner tube 21. Therefore, the saddle 10 is rotatable relative to the seat post 20 since the inner tube 21 could be rotatable relative to the barrel portion 11 of the bracket 1. Once the saddle 10 is adjusted to a suitable position, the controlling member 33 is operated to be tightened such that the second toothed face 311 of the engaging block 31 is engaged with the first toothed face 211 of the inner tube 21 so as to retain the saddle 10 in a certain inclined angle. It is convenient to be operated.

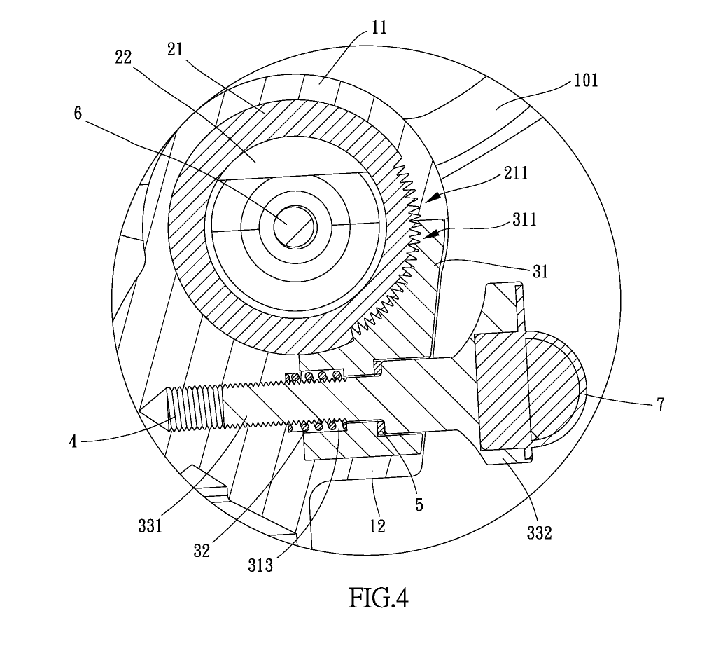

As shown in FIG. 4 and referring to FIG. 2, the engaging block is substantially L-shaped which defines a concave 312 corresponding to the opening 131 of the barrel portion 11, wherein the first toothed face 211 is disposed on a wall of the concave 312. The concave 312 of the engaging block 31 is also contoured to fit the inner tube 21. Moreover, the engaging block 31 has a recess 313 for accommodating the elastic member 32.

Specifically, the controlling member 33 has a bolt portion 331 and an operating head 332, as shown in FIG. 2. The bolt portion 331 has a thread section 4 at one end for being screwed in the wall of the cavity 121. The operating head 332 is arranged outside the extending portion 12, so that the controlling member 33 is convenient to be operated so as to manually control the movement of the engaging block 31.

Furthermore, the inner tube 21 has two notches 212 corresponding to the two saddle rails 101 and each of the two caps 22 has a clamping groove 221 corresponding to the respective notch 212 of the inner tube 21, as shown in FIG. 2. The two clamping grooves 221 of the two caps 22 cooperate with the two notches 212 of the inner tube 21 to clamp the two saddle rails 101 so as to secure the saddle 10 on the bracket 1, as shown in FIG. 1.

Moreover, a washer 5 is mounted around the bolt portion 331 of the controlling member 33. A fastener 6 laterally passes through the two caps 22 for securing the two caps 22 with each other. Particularly, a lighting device 7 could be mounted on the operating head 332 of the controlling member 33 opposite to the bolt portion 331 such that the lighting device is arranged at a rear side of the bracket 1 for warning.

What is claimed is:

1. An adjusting device for a saddle, which is adapted to be mounted between two saddle rails and a seat post, comprising:
a bracket mounted on a top of the seat post, and having a barrel portion and an extending portion defined at an outer periphery of the barrel portion, the barrel portion having an axial hole therethrough and an opening defined in an inner wall of the barrel portion, the extending portion having a cavity communicating with the axial hole of the barrel portion via the opening;
a supporting assembly for clamping the two saddle rails having an inner tube rotatably disposed in the barrel portion of the bracket and two caps fixed on two opposite ends of the inner tube, the inner tube having a first toothed face corresponding to the opening of the barrel portion; and
an adjusting assembly disposed in the cavity of the extending portion, and having an engaging block and a controlling member, the engaging block having a second toothed face for engagement with the first toothed face of the inner tube to retain the inner tube, the controlling member passing through the engaging block and locked in a wall of the cavity for securing the engaging block;
wherein the controlling member is rotated in a tight state where the engaging block is engaged with the inner tube, and in a loose state where the engaging block is disengaged from the inner tube so that an inclined angle of the saddle is allowed to be adjusted.

2. The adjusting device for the bicycle saddle as claimed in claim 1, wherein the engaging block is substantially L-shaped which defines a concave corresponding to the opening of the barrel portion, and the first toothed face is disposed on a wall of the concave.

3. The adjusting device for the bicycle saddle as claimed in claim 1, wherein the adjusting assembly further comprises an elastic member interposed between the wall of the cavity and the engaging block; and the engaging block has a recess for accommodating the elastic member.

4. The adjusting device for the bicycle saddle as claimed in claim 1, wherein the controlling member has a bolt portion and an operating head; the bolt portion has a thread section at one end thereof for being screwed in the wall of the cavity; and the operating head is arranged outside the extending portion for controlling movement of the engaging block.

5. The adjusting device for the bicycle saddle as claimed in claim 4, further comprising a washer mounted around the bolt portion of the controlling member.

6. The adjusting device for the bicycle saddle as claimed in claim 4, further comprising a lighting device mounted on the operating head of the controlling member opposite to the bolt portion.

7. The adjusting device for the bicycle saddle as claimed in claim 1, wherein the inner tube has two notches corresponding to the two saddle rails and each of the two caps has a clamping groove cooperating with the respective notch of the inner tube to clamp the associated saddle rail.

8. The adjusting device for the bicycle saddle as claimed in claim 7, further comprising a fastener laterally passing through the two caps for securing the two caps with each other.
